(19) United States
(12) Patent Application Publication
(10) Pub. No.: US 2025/0126509 A1
(43) Pub. Date: Apr. 17, 2025

(54) TRAFFIC STEERING FOR DUCTING INTERFERENCE

(71) Applicant: T-MOBILE INNOVATIONS LLC, Overland Park, KS (US)

(72) Inventors: Roopesh Kumar POLAGANGA, Bothell, WA (US); Kurt M. LANDUYT, Parkville, MO (US); Meenakshi DHAR, Bellevue, WA (US)

(21) Appl. No.: 18/380,494

(22) Filed: Oct. 16, 2023

(51) Int. Cl. H04W 28/02; H04W 36/00; H04W 36/22

(52) U.S. Cl. CPC H04W 28/0268; H04W 36/00837; H04W 36/22

(57) ABSTRACT

Systems and methods are provided for ducting-based traffic steering. A telecommunications network manager can identify when tropospheric ducting is experienced, or expected to be experienced, at a network layer band and dynamically adjust traffic steering. Specifically, the manager can reallocate user devices to layers that are not experiencing or not anticipated to experience ducting. A load capacity of different layers is monitored such that devices are not transferred to already-overloaded layers. Once ducting is no longer experienced at the layer, any offloaded devices can be transferred back to their original layer.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for steering traffic for ducting interference. More particularly, in aspects set forth herein, systems and methods enable dynamic and intelligent reallocation or reassignment of user devices when ducting interference is detected.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for ducting-based traffic steering, in accordance with aspects herein, in accordance with aspects herein;

FIG. 3 a flow diagram of a method for ducting-based traffic steering, in accordance with aspects herein, in accordance with aspects herein; and

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to traffic steering for ducting interference. Tropospheric ducting is a natural phenomenon that impacts telecommunications networks in certain frequencies in, for example, Time Division Duplex (TDD) (e.g., n41). Due to this phenomenon, downlink signals of cell traffic are ducted to follow the Earth's curve and interference can be experienced in the uplink traffic of other cells with the same frequency. This can result in a degraded experience for users.

The growing prevalence of 5G brings a network capacity boost and enables operators to provide new services like Fixed Wireless Access (FWA), which is a more cost-effective and efficient alternative for providing broadband in areas with limited access to fixed broadband services. Such solutions tend to stay connected most of the time and have a large consumption of data so large bandwidth capacity layers, such as n41, are desirable. Because of a potential for ducting at the n41 layer, measures are needed to ensure positive user experiences. The present disclosure describes dynamic traffic steering when experiencing ducting interference to preserve user experiences.

Accordingly, a first aspect of the present disclosure is directed to a system for ducting-based traffic steering. The system comprises one or more processors and one or more computer-readable media storing computer-usable instructions that, when executed by the one or more processors, cause the one or more processors to: identify one or more layers experiencing tropospheric ducting, identify one or more user devices at the one or more layers experiencing tropospheric ducting, and reallocate the one or more user devices from the one or more layers experiencing tropospheric ducting to at least one other layer.

A second aspect of the present disclosure is directed to a method for ducting-based traffic steering. The method comprises identifying ducting at a first layer at a first time; identifying a first set of user devices on the first layer; based on a throughput of each of the user devices of the first set of user devices, prioritizing each of the user devices for reallocation to at least one layer different than the first layer; communicating a handoff instruction to one or more first user devices of the first set of user devices having a priority value greater than a predetermined threshold, wherein the handoff instruction indicates that the one or more first user devices is moving to the at least one layer different than the first layer; and upon determining ducting is not detected at the first layer at a second time after the first time, communicating a handoff instruction to the one or more first user devices to move back to the first layer.

Another aspect of the present disclosure is directed to a system for ducting-based traffic steering. The system comprises one or more processors and one or more computer-readable media storing computer-usable instructions that, when executed by the one or more processors, cause the one or more processors to: identify ducting at a first layer at a first time; identify a first set of user devices on the first layer; based on a throughput of each of the user devices of the first set of user devices, prioritize each of the user devices for reallocation to at least one layer different than the first layer; communicate a handoff instruction to one or more first user devices of the first set of user devices having a priority value greater than a predetermined threshold, wherein the handoff instruction indicates that the one or more first user devices is moving to the at least one layer different than the first layer; and upon determining ducting is not detected at the first layer at a second time after the first time, communicate a handoff instruction to the one or more first user devices to move back to the first layer.

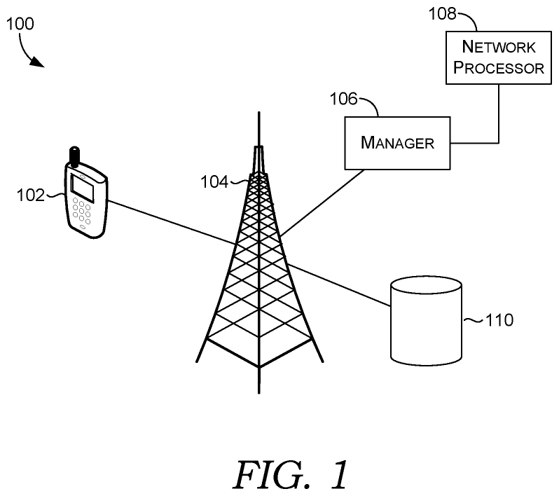

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

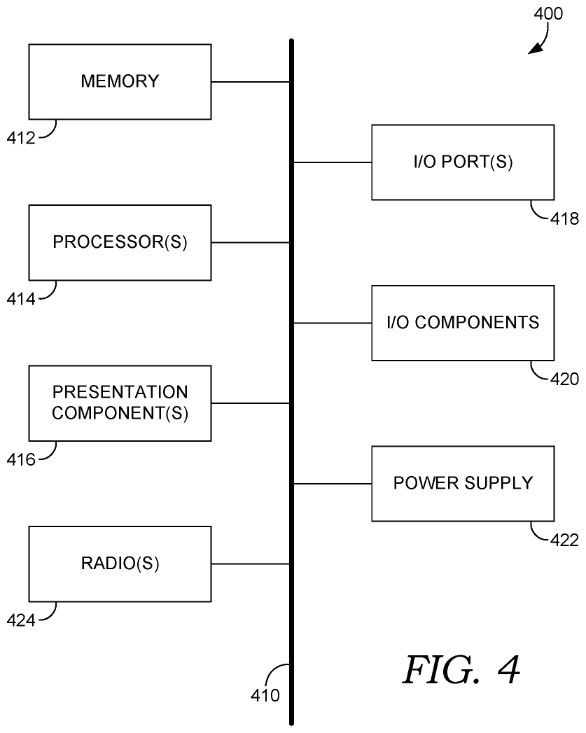

A network cell may comprise a base station to facilitate wireless communication between a communications device within the network cell, such as communications device 400 described with respect to FIG. 4, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

In aspects, tower 104 communicates with one or more user devices, such as UE 102. UE's communicate with the tower 104 using different layers, having different frequency bands. For example, n41 (2500 MHz) is commonly referred to as the 2.5 GHz 5G band and is a commonly deployed frequency. The n41 layer/band is widely popular due to its availability and is often prioritized for use among user devices. However, n41 is susceptible to tropospheric ducting, as noted above. The tower 104, also referred to as the e-Node B or g-Node B, depending on the relevant telecommunications network discussed, can intelligently steer traffic to avoid negative network effects associated with ducting (e.g., decrease in uplink ability, which negatively impacts downlink). The intelligent mitigation discussed here can occur at the eNodeB or gNodeB level (e.g., tower 104) via a manager 106 located at the gNodeB. The manager 106, in aspects, can be centralized or disparate. In preferred embodiments, the manager 106 is gNodeB-specific and located at each gNodeB in a relevant network.

The manager 106 can communicate with a network processor 108. The network processor 108 can communicate directly with the manager 106/gNodeB 104. Information obtained by the gNodeB 104 is communicated to the network processor 108 and vice versa. Thus, information obtained at the network processor 108 from sources other than the gNodeB 104 can be communicated to/with the gNodeB 104. For instance, the network processor 108 can communicate with meteorological sources to obtain temperature data, location data, weather data, etc., that are relevant to the gNodeB 104 when analyzing tropospheric ducting. The environment 100 further comprises a data store 110 that can be utilized to locally or remotely store any data related to the ducting evaluations.

The network processor 108 is utilized to identify ducting. Ducting can be said to occur when one or more ducting criteria is detected for a predetermined period of time. For example, a minimum predetermined period of time can be 20 minutes. In embodiments, a predetermined period of time is 24 hours. Alternatively, the manager 106 could be utilized to identify ducting in the same manner as described with respect to the network processor 108. The manager 106 could identify ducting only at a specific site level while the network processor 108 can evaluate ducting at all sites within a network and communicate that with specific sites thereafter.

The ducting can be identified using one or more ducting criteria based on data gathered and communicated to the eNodeB 104. For each site, and each cell within a cite, data can be gathered at predetermined time intervals including date of data acquisition, a time stamp indicating a time the data was acquired, a location associated with the site/cell, a site ID (if applicable), a cell name (if applicable), and the like. Ducting is determined to be present utilizing specific parameters including uplink PUSCH (physical uplink shared channel) interference, uplink power, and the like. In embodiments, ducting is identified when the uplink PUSCH receiving interference power is greater than-105 dBm and uplink power is greater than 5 for a predetermined time period. In further embodiments, the predetermined time period is 24 hours. This data can be collected across a network so it can be identified which site in a network is experiencing ducting. The network processor 108, for instance, can query each site in a network to obtain the data needed to monitor for ducting. The network processor 108 queries each site at predetermined times such as, for instance, hourly. The time series of data is accumulated to identify sites that are experiencing ducting such that the intelligent traffic steering described herein can occur.

When ducting is identified, one or more UEs, such as UE 102 can be relocated to a layer different than the layer that is currently impacted by ducting. For instance, if n41 is the layer where ducting is occurring and a first user device is presently utilizing n41, the first user device can be relocated/steered to another layer different than n41, such as the n66 layer or n71 layer, depending on the needs of the first user device. Generally, user devices with low throughput requirements and delay sensitive services (such as voice) are moved to different layers. Delay sensitive services are highly affected by ducting and, thus, UEs utilizing such delay sensitive services are prioritized over other UEs not utilizing delay sensitive services when determining to move UEs to other layers. Delay sensitive services/applications, as used herein, refers generally to any service/application where high or variable latency will negatively affect performance. These may also be called low latency applications. Exemplary delay sensitive services can include voice, video consumption/streaming, gaming, etc.

The manager 106 can continuously monitor load on other layers to quickly identify available layers in which to transfer traffic. Alternatively, manager 106 can evaluate current load status for each layer and predetermined intervals of time. Additional layers can be identified based on capacity of the layer. For instance, if ducting is detected at n41 and the only other available layers for the impacted UEs is n71 and n66, both of which are at capacity, then the impacted UEs on n41 are not able to be moved to a different layer. If, however, either or both of the additional layers have available capacity, the manager 106 can identify both as available options to which the impacted UEs can be transferred. Furthermore, if additional capacity remains after all of the delay sensitive services UEs have been transferred, additional non-delay sensitive services can be offloaded to different layers having capacity, as well. Put simply, the manager 106 can identify any layers having capacity to take on more UEs, prioritize those layers, and can further prioritize UEs to be offloaded to those layers based on services/applications utilized (e.g., delay sensitive services will be a higher priority to offload than non-delay sensitive services). In embodiments, the manager 106 monitors load at predetermined intervals until traffic is offloaded to a different layer due to ducting and then the manager 106 continuously monitors load to ensure that the offloading does not exceed any predetermined load thresholds for available layers. The manager 106 can continuously monitor until the offloaded traffic is returned to the original layer.

When ducting is identified, an instruction is communicated to impacted UEs on the effected layer. When a UE is currently connected to the effected layer (e.g., the UE is in a connected mode), a handoff/handover instruction can be communicated to the UE to handoff/transfer to another layer (e.g., Inter-Frequency Handover). If a UE is not currently connected (e.g., the UE is in idle mode), an instruction to reconnect to a different layer (i.e., a layer different than the effected layer) upon establishing a new connection can be communicated to the UE. This message to the idle device will prevent an attempted reconnection to the effected layer should the idle device attempt to create a new network session while ducting is still identified at the effected layer. The instruction to the idle UE can include a list of available layers and a prioritization value for each of the available layers that has been reprioritized as a result of a preferred layer (i.e., the highest priority value layer) experiencing ducting. The prioritization values for layers can be re-ordered at any point by the manager 106 when ducting is identified at one or more layers.

As noted above, the manager 106 can continuously or periodically monitor loads of layers and/or ducting interference. When ducting is no longer detected, the offloaded traffic may be returned to its original layer. In embodiments, a predetermined time interval of 15 minutes is used to determine that ducting is no longer present. For instance, if at 11:00 am no ducting is detected and again at 11:15 am no ducting is detected, the manager 106 can presume that ducting is no longer experienced and predict that ducting is not an issue so that traffic can be steered back to the layer. Sensitivity for ducting identification is configurable.

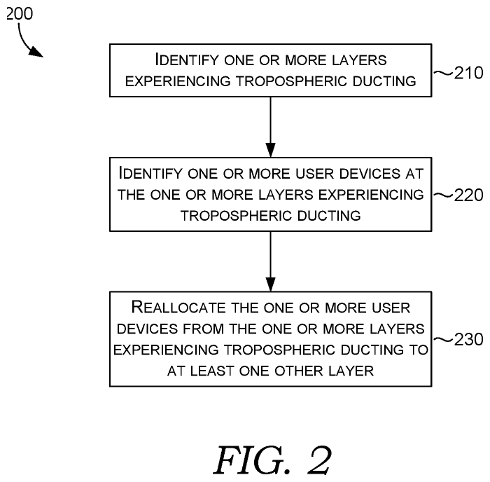

Turning to FIG. 2, a flow diagram 200 is provided illustrating a flow for ducting-based traffic steering. Initially, at block 210, it is identified that one or more layers are experiencing tropospheric ducting, including a first layer. At block 220, it is identified that there are one or more user devices at the one or more layers experiencing tropospheric ducting. At block 230, the one or more user devices from the one or more layers experiencing tropospheric ducting are reallocated, or moved, to at least one other layer.

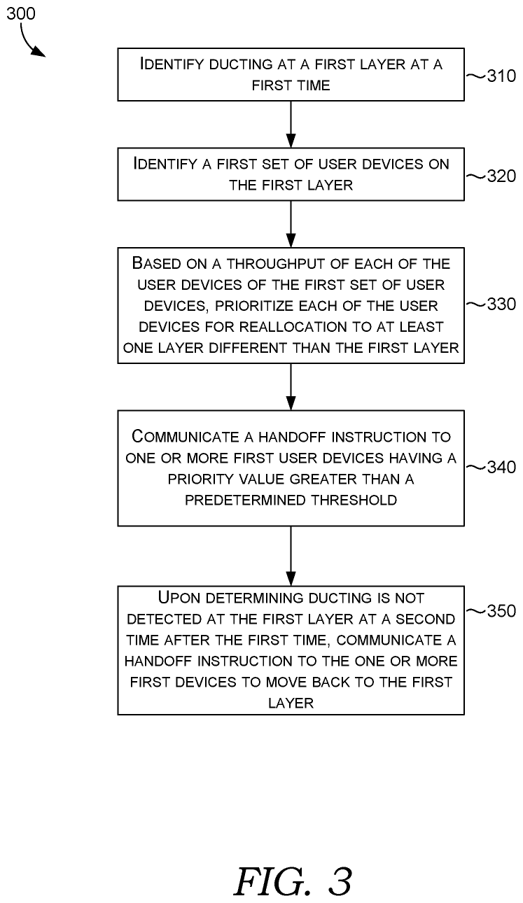

Referring to FIG. 3, a flow diagram 300 is provided illustrating a flow for ducting-based traffic steering. Initially, at block 310 ducting is identified at a first layer at a first time. At block 320 a first set of user devices on the first layer is identified. Based on a throughput of each of the user devices of the first set of user devices, each of the user devices are prioritized for reallocation to at least one layer different than the first layer at block 330. At block 340, a handoff instruction is communicated to one or more first user devices of the first set of user devices having a priority value greater than a predetermined threshold. The handoff instruction indicates that the one or more first user devices is moving to the at least one layer different than the first layer. Upon determining ducting is not detected at the first layer at a second time after the first time, a handoff instruction is communicated to the one or more first user devices to move back to the first layer at block 350.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for ducting-based traffic steering, the system comprising:
one or more processors; and
one or more computer-readable media storing computer-usable instructions that, when executed by the one or more processors, cause the one or more processors to:
identify one or more layers experiencing tropospheric ducting, including a first layer;
identify one or more user devices at the one or more layers experiencing tropospheric ducting; and
reallocate the one or more user devices from the one or more layers experiencing tropospheric ducting to at least one other layer.

2. The system of claim 1, wherein the one or more processors is further configured to prioritize reallocation of the one or more user devices.

3. The system of claim 2, wherein a first user device utilizing delay sensitive services is designated a higher priority value than a second user device not utilizing delay sensitive services.

4. The system of claim 3, wherein the first user device is reallocated to a second layer different than the first layer experiencing ducting prior to the second user device.

5. The system of claim 3, wherein delay sensitive services comprise conversational voice services.

6. The system of claim 4, wherein at least one user device on one or more other layers different than the first layer that is experiencing ducting is reallocated to other layers after devices on the first layer are reallocated.

7. The system of claim 1, wherein the first layer is an n41 layer.

8. The system of claim 1, wherein the one or more processors is further configured to communicate a handoff instruction to each of the one or more user devices on the first layer.

9. The system of claim 1, wherein the one or more processors is further configured to communicate a reconnection instruction to any idle user device instructing the idle user device to reconnect to a layer different than the first layer when the idle user device reconnects.

10. A method for ducting-based traffic steering, the method comprising:
identifying ducting at a first layer at a first time;
identifying a first set of user devices on the first layer;
based on a throughput of each of the user devices of the first set of user devices, prioritizing each of the user devices for reallocation to at least one layer different than the first layer;
communicating a handoff instruction to one or more first user devices of the first set of user devices having a priority value greater than a predetermined threshold, wherein the handoff instruction indicates that the one or more first user devices is moving to the at least one layer different than the first layer; and
upon determining ducting is not detected at the first layer at a second time after the first time, communicating a handoff instruction to the one or more first user devices to move back to the first layer.

11. The method of claim 10, wherein a user device having a low throughput is assigned a higher priority value than a user device having a high throughput.

12. The method of claim 10, wherein a first user device utilizing delay sensitive services is assigned a higher priority value than a second user device not utilizing delay sensitive services.

13. The method of claim 12, wherein delay sensitive services comprise conversational voice services.

14. The method of claim 10, wherein the first layer is an n41 layer.

15. The method of claim 10, further comprising communicating a reconnection instruction to any idle user device instructing the idle user device to reconnect to a layer different than the first layer when the idle user device reconnects.

16. The method of claim 15, wherein the reconnection instruction includes at least a re-prioritized listing of a plurality of layers, where each of the plurality of layers is assigned a priority value, where the first layer is removed from the re-prioritized listing of the plurality of layers.

17. A system for ducting-based traffic steering, the system comprising:
one or more processors; and
one or more computer-readable media storing computer-usable instructions that, when executed by the one or more processors, cause the one or more processors to:
identify ducting at a first layer at a first time;
identify a first set of user devices on the first layer;
based on a throughput of each of the user devices of the first set of user devices, prioritize each of the user devices for reallocation to at least one layer different than the first layer;
communicate a handoff instruction to one or more first user devices of the first set of user devices having a priority value greater than a predetermined threshold, wherein the handoff instruction indicates that the one or more first user devices is moving to the at least one layer different than the first layer; and
upon determining ducting is not detected at the first layer at a second time after the first time, communicate a handoff instruction to the one or more first user devices to move back to the first layer.

18. The system of claim 17, wherein the one or more processors is further configured to communicate a reconnection instruction to any idle user device instructing the idle user device to reconnect to a layer different than the first layer when the idle user device reconnects.

19. The system of claim 17, wherein the reconnection instruction includes at least a re-prioritized listing of a plurality of layers, where each of the plurality of layers is assigned a priority value, where the first layer is removed from the re-prioritized listing of the plurality of layers.

20. The system of claim 18, wherein a first user device utilizing delay sensitive services is assigned a higher priority value than a second user device not utilizing delay sensitive services; and wherein delay sensitive services comprise conversational voice services.
